(19) United States
(12) Patent Application Publication
(10) Pub. No.: US 2026/0113818 A1
(43) Pub. Date: Apr. 23, 2026

(54) ELECTROMAGNETIC WAVE HEATING DEVICE

(71) Applicant: Mitsubishi Electric Corporation, Tokyo (JP)

(72) Inventors: Hidetoshi MAKIMURA, Tokyo (JP); Yuta SUGIYAMA, Tokyo (JP)

(73) Assignee: Mitsubishi Electric Corporation, Tokyo (JP)

(21) Appl. No.: 19/409,052

(22) Filed: Dec. 4, 2025

Related U.S. Application Data
(63) Continuation of application No. PCT/JP2023/026704, filed on Jul. 21, 2023.

(51) Int. Cl. H05B 6/76

(52) U.S. Cl. CPC H05B 6/766

(57) ABSTRACT

A conductive housing includes a first shield and a second shield, and a conductive mesh in the second shield that forms an electrically closed space between the first shield and the second shield has a shape in which a plurality of mesh cells, each enclosed by straight sides of equal length, are arranged in an array.

### CROSS REFERENCE TO RELATED APPLICATION

This application is a Continuation of PCT International Application No. PCT/JP2023/026704, filed on Jul. 21, 2023, which is hereby expressly incorporated by reference into the present application.

### TECHNICAL FIELD

The present disclosure relates to an electromagnetic wave heating device including a conductive mesh that has transparency, and shields electromagnetic waves between the inside and outside of the housing.

BACKGROUND ART

Microwave ovens are known to include punched metal that has transparency, and does not allow the leakage of electromagnetic waves from inside to outside the housing.

For example, a microwave oven disclosed in Patent Literature 1 has punched metal at the central portion of the door panel to prevent the leakage of microwaves through the central portion section of the door panel.

### CITATION LIST

### Patent Literature

Patent Literature 1: JP 2014-081091 A

### SUMMARY OF INVENTION

### Technical Problem

Through a variety of studies on conductive meshes that do not allow the leakage of electromagnetic waves from inside to outside a housing, the present inventors found that, when electromagnetic waves are incident on a conductive mesh, the conductive mesh is heated by an induced electric current, and the conductive mesh undergoes deterioration (burning, melting, disconnection, etc.) as the temperature increases due to the heating.

If sufficient thickness is ensured as a conductive mesh, the sheet resistance value of the conductive mesh can be suppressed, thereby preventing temperature of the conductive mesh from rising. However, due to manufacturing constraints, the thickness of conductive meshes cannot be made greater than a certain level, in some cases.

In addition, even without ensuring sufficient thickness of a conductive mesh, by lowering the opening ratio of the conductive mesh, that is, by increasing the ratio of the conductor area to the total area covered by the conductive mesh, the sheet resistance value can be suppressed, thereby preventing temperature rise in the conductive mesh. However, reducing the opening ratio of a conductive mesh results in the impairment of the see-through property, that is, transparency, of the conductive mesh, and the impairment of the visibility of the inside of the housing, making it difficult to observe the inside of the housing.

That is, for example, in applications where electromagnetic waves with high electric power density are shielded such as in a microwave oven, balancing the prevention of temperature rise of a conductive mesh with its transparency while satisfying manufacturing constraints involves a trade-off.

The present disclosure has been made in view of the matters described above, and an object thereof is to obtain a conductive housing that can prevent the deterioration of a conductive mesh caused by heating due to electromagnetic waves.

### Solution to Problem

An electromagnetic wave heating device according to the present disclosure includes: a conductive housing including a first shield being conductive and having an opening, and a second shield that has a conductive mesh with a shape in which a plurality of mesh cells, each enclosed by straight sides of equal length each having a line width being equal to or less than 10 μm, are arranged in an array, and is provided at the opening of the first shield, the conductive mesh being electrically connected to the first shield to form an electrically closed space by the first shield and the second shield, an electromagnetic wave generator to generate an electromagnetic wave; and an electromagnetic wave emitter that is housed inside the conductive housing, and emits the electromagnetic wave from the electromagnetic wave generator into a space of the conductive housing, wherein electrical connection between the first shield and the conductive mesh in the second shield is established at points of contact or capacitive coupling between the first shield and the conductive mesh of the second shield arranged with an interval which is equal to or less than 1/10 of a wavelength of the electromagnetic wave generated by the electromagnetic wave generator.

### Advantageous Effects of Invention

By adopting, as the shape of a conductive mesh, a shape in which mesh cells, each enclosed by straight sides of equal length, are arranged in an array, the present disclosure makes it possible to reduce the difference between the maximum temperature and minimum temperature of lines enclosing the mesh cells to lower the maximum temperature, and prevent deterioration due to the temperature rise of the conductive mesh in a state where the visibility is maintained.

### BRIEF DESCRIPTION OF DRAWINGS

FIG. 1 is a cross-sectional view schematically illustrating an electromagnetic wave heating device according to a first embodiment.

FIG. 2 is a front view of main units of a conductive mesh (mesh cells: regular squares) in the electromagnetic wave heating device according to the first embodiment.

FIG. 3 is an explanatory diagram illustrating the polarization direction of electromagnetic waves that are incident on a conductive mesh in a case where mesh cells, which are the unit meshes of the conductive mesh, are regular squares.

FIG. 4 is a drawing illustrating the simulation results of the temperature distribution in lines enclosing a regular-square mesh cell which is the unit mesh of a conductive mesh when X-direction polarized electromagnetic waves have been incident on the mesh cell in a case where the mesh cells are regular squares having sides parallel to the X axis and the Y axis.

FIG. 5 is an explanatory diagram illustrating the polarization direction of electromagnetic waves that are incident on a conductive mesh in a case where mesh cells, which are the unit meshes of the conductive mesh, are regular hexagons.

FIG. 6 is an explanatory diagram illustrating the polarization direction of electromagnetic waves that are incident on a conductive mesh in a case where mesh cells, which are the unit meshes of the conductive mesh, are equilateral triangles.

FIG. 7 is a front view of main units of a conductive mesh (mesh cells: regular hexagons) in the electromagnetic wave heating device according to the first embodiment.

FIG. 8 is a drawing illustrating the maximum temperature and minimum temperature of lines enclosing a mesh cell in a mesh cell model of a conductive mesh.

FIG. 9 is an explanatory diagram schematically illustrating a sensor device according to a second embodiment.

### DESCRIPTION OF EMBODIMENTS

### First Embodiment

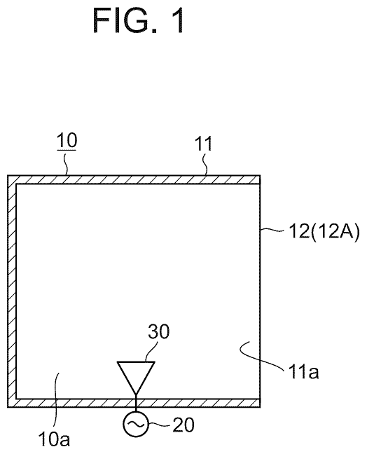

An electromagnetic wave heating device according to a first embodiment is explained using FIGS. 1 to 8.

The electromagnetic wave heating device according to the first embodiment is a device, such as a cooking microwave oven or a microwave heating device, for heating a heating target object which is the target object to be heated by emitting electromagnetic waves onto the heating target object.

Since main constituent elements of these electromagnetic heating devices are the same, the following explains a microwave oven as an example.

As illustrated in FIG. 1, the electromagnetic wave heating device according to the first embodiment includes a conductive housing 10, an electromagnetic wave generating unit 20, and an electromagnetic wave emitting unit 30.

FIG. 1 schematically illustrates the conductive housing 10, the electromagnetic wave generating unit 20, and the electromagnetic wave emitting unit 30.

The electromagnetic wave generating unit 20 and the electromagnetic wave emitting unit 30 are housed inside the conductive housing 10.

Note that the electromagnetic wave generating unit 20 may be located outside the conductive housing 10.

The conductive housing 10 has a first shield 11 and a second shield 12.

The first shield 11 has an opening 11a, is a conductive, and has a box shape.

For example, the first shield 11 has a rectangular parallelepiped shape, and has the opening 11a on its front surface, which is one of its six surfaces.

For example, the first shield 11 is formed using carbon steel, special steel, or a conductive material of another alloy.

The second shield 12 is provided at the opening 11a of the first shield 11, and has a conductive mesh 12A disposed at the central portion and a holder (not illustrated) that holds the conductive mesh 12A.

The second shield 12 is a door openably and closably attached to the opening 11a of the first shield 11, and blocks the opening 11a of the first shield 11 when closed.

The first shield 11 and the second shield 12 form a space 10a of the conductive housing 10.

A heating target object (not illustrated) is housed in the space 10a of the conductive housing 10.

FIG. 1 schematically illustrates the first shield 11 and the second shield 12.

The conductive mesh 12A is electrically connected to the first shield 11 to form an electrically closed space between the first shield 11 and the conductive mesh 12A, or a so-called closed space, as the internal space 10a of the conductive housing 10.

The electrical connection between the conductive mesh 12A and the first shield 11 does not mean contact at one point, but refers to a connection through contact or capacitive coupling at a narrow spacing that achieves sufficient capability to shield electromagnetic waves.

For example, the first shield 11 and the conductive mesh 12A may be electrically connected by providing points of contact or capacitive coupling arranged with an interval which is equal to or less than 1/10 of the wavelength of electromagnetic waves to be shielded, or electromagnetic waves generated by the electromagnetic wave generating unit 20, in this first embodiment. Most typically, the conductive mesh 12A is electrically connected to the first shield 11 by making contact with the first shield 11 around the entire perimeter of the end of the opening 11a of the first shield 11.

In addition, to facilitate the electrical connection between the conductive mesh 12A and the first shield 11, instead of a mesh, a solid conductive member may be provided around the entire perimeter or at part of the end of the conductive mesh 12A.

The holder that holds the conductive mesh 12A covers the whole surface of the conductive mesh 12A, and has a flat plate shape formed using a light-transmitting material of inorganic glass or heat-resistant polyimide.

The first shield 11 and the conductive mesh 12A function as a so-called conductor shield that shields electromagnetic waves emitted from the electromagnetic wave emitting unit 30 between the inside and outside of the space 10a of the conductive housing 10. That is, electromagnetic waves emitted from the electromagnetic wave emitting unit 30 are confined in the space 10a of the conductive housing 10.

Note that, due to the reversibility of electromagnetic waves, preventing the conductive mesh 12A from allowing electromagnetic waves emitted from the electromagnetic wave emitting unit 30 to leak from inside to outside the space 10a of the conductive housing 10 is equivalent to preventing the conductive mesh 12A from allowing electromagnetic waves from outside the space 10a of the conductive housing 10 to enter the space 10a of the conductive housing 10.

For example, the electromagnetic wave generating unit 20 is a magnetron that generates electromagnetic waves.

The electromagnetic wave generating unit 20 is controlled by a controller (not illustrated) housed inside the conductive housing 10.

The electromagnetic wave emitting unit 30 emits electromagnetic waves generated by the electromagnetic wave generating unit 20 to the inside of the space 10a of the conductive housing 10, and heats a heating target object housed in the space 10a of the conductive housing 10.

For example, the electromagnetic wave emitting unit 30 includes an antenna that emits electromagnetic waves.

Note that the electromagnetic wave emitting unit 30 may include an opening of a waveguide that emits electromagnetic waves generated by the electromagnetic wave generating unit 20.

The conductive mesh 12A has a shape in which mesh cells 12a, each enclosed by straight sides of equal length, are arranged in an array.

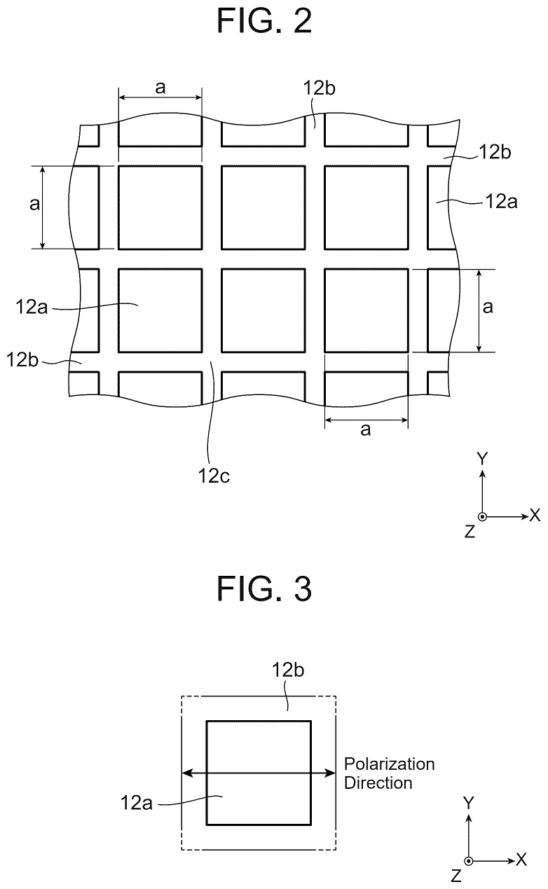

As illustrated in an expanded front view of main units in FIG. 2, the conductive mesh 12A has a shape in which the regular-square mesh cells 12a are enclosed by lines 12b, and the mesh cells 12a are arranged in an array in the X-axis and Y-axis directions in the drawing, that is, in a grid.

Each mesh cell 12a is a regular square with each side having a length a, and the line widths of the lines 12b are the same across the whole length.

The length of the diagonal in each mesh cell 12a is equal to or less than the wavelength of electromagnetic waves that are incident on the conductive mesh 12A, and is a length longer than the wavelength of visible light. In addition, the length a of each side is also a length longer than the wavelength of visible light.

The X axis corresponds to the left-right direction, the Y axis corresponds to the up-down direction, and the Z-axis corresponds to the front-rear direction.

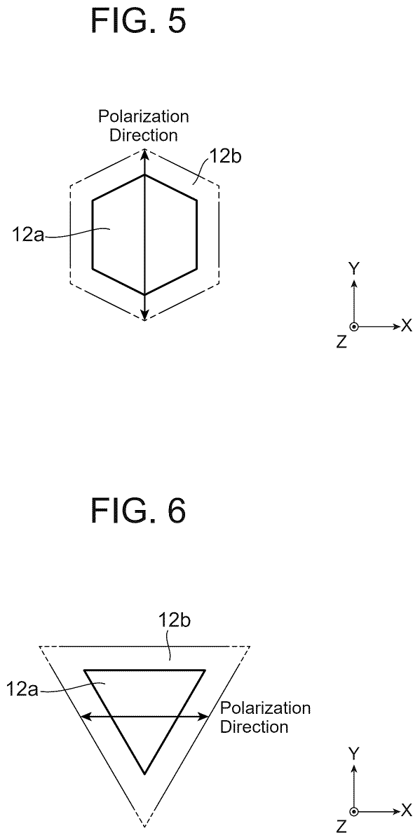

Note that, as explained later specifically, each mesh cell 12a may be a regular hexagon illustrated in FIG. 5 or an equilateral triangle illustrated in FIG. 6. In summary, it is sufficient when the shapes of mesh cells 12a are regular n-gons, each enclosed by straight sides of equal length. n is a natural number which is equal to or greater than three.

The conductive mesh 12A ensures transparency through the mesh cells 12a, and the lines 12b enclosing the mesh cells 12a shield electromagnetic waves.

The maximum distance between sides enclosing the respective mesh cells 12a in the conductive mesh 12A is equal to or less than the wavelength of electromagnetic waves that are incident on the conductive mesh 12A, or electromagnetic waves emitted from the electromagnetic wave emitting unit 30 in the first embodiment, and the minimum distance is a length longer than the wavelength of visible light.

In a case where the shape of each mesh cell 12a is a regular square, the length of each diagonal is equal to or less than the wavelength of the electromagnetic waves, and the length a of each side is a length longer than the wavelength of visible light.

In a case where the shape of each mesh cell 12a is a regular hexagon, the length of each line segment linking opposite corners is equal to or less than the wavelength of the electromagnetic waves, and the distance between each pair of opposite sides is a length longer than the wavelength of visible light.

In a case where the shape of each mesh cell 12a is an equilateral triangle, the length of each side is equal to or less than the wavelength of the electromagnetic waves, and the length of each perpendicular line is a length longer than the wavelength of visible light.

Next, the behavior of electromagnetic waves in a case where the electromagnetic waves are incident on the conductive mesh 12A is explained.

In a case where electromagnetic waves enter a conductor having a component in a direction parallel to the polarization direction of the electromagnetic waves, an electric current in the direction parallel to the polarization direction is induced in the conductor.

For example, in a case where the polarization direction of electromagnetic waves in the regular-square mesh cells 12a illustrated in FIG. 2 is parallel to the X axis, an electric current is induced in lines 12b extending in the X-axis direction, and, in a case where the polarization direction of electromagnetic waves in the regular-square mesh cells 12a illustrated is parallel to the Y axis, an electric current is induced in lines 12b extending in the Y-axis direction.

In addition, in a case where the polarization of electromagnetic waves is inclined from the Y direction to the X direction on the X-Y plane, an electric current is induced in both lines 12b extending in the X-axis direction and lines 12b extending in the Y-axis direction. This is because the polarization direction of the electromagnetic waves has both an X-direction component and a Y-direction component.

Now, when the angle between the X axis and the polarization direction of electromagnetic waves is q, and the incident electric field amplitude is 1, the amplitude of the X component of the electric field formed by the electromagnetic waves is cosq, and the amplitude of the Y component of the electric field formed by the electromagnetic waves is sinq.

That is, an electric current induced in lines 12b is proportional to the electric field amplitude. The strongest electric current is induced in a case where the polarization direction of electromagnetic waves and the direction of lines 12b are parallel to each other, and ideally an electric current is not induced in a case where the directions are orthogonal to each other.

When an electric current is induced in lines 12b, electric power is consumed as heat due to the electrical resistance of the lines 12b, and the temperature of the lines 12b rises.

Taking into account the considerations, the present inventors conducted a numerical simulation of the heat (temperature distribution) of the lines 12b enclosing the mesh cells 12a in a case where electromagnetic waves are incident on the conductive mesh 12A.

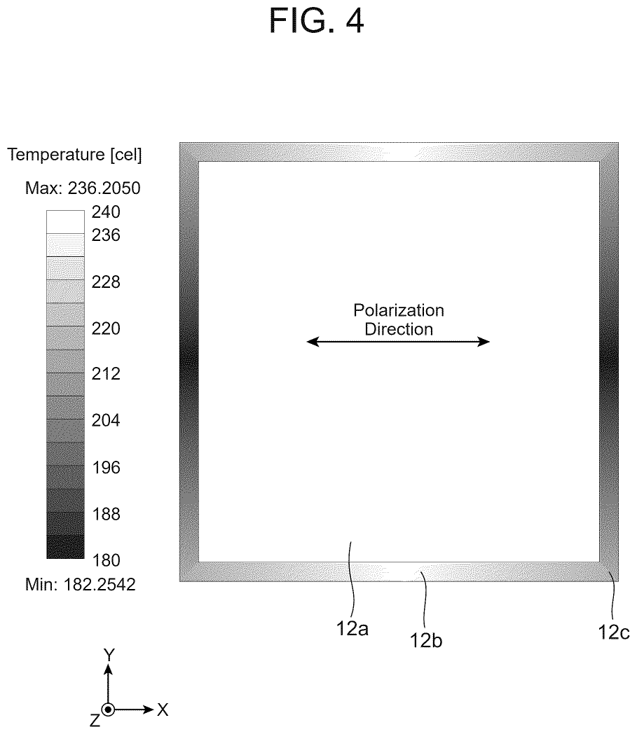

The numerical simulation was conducted for the regular-square mesh cells 12a illustrated in FIG. 2, considering a case where the polarization of electromagnetic waves is parallel to the X axis as illustrated in FIGS. 3 and 4.

FIGS. 3 and 4 illustrate only one mesh cell 12a, that is, a unit mesh.

FIG. 4 illustrates the numerical simulation results.

The temperature distribution illustrated in FIG. 4 is the temperature distribution on the lines 12b of a unit mesh of the conductive mesh 12A after a certain length of time in a case where an X-direction polarized electromagnetic field was incident on the conductive mesh 12A.

As can be understood from FIG. 4, the temperature of the lines 12b parallel to the X-axis direction is high, and the temperature of the lines 12b parallel to the Y-axis direction is low.

In addition, the middle sections of the lines 12b extending in the X-axis direction have the maximum temperature, and the middle sections of the lines 12b extending in the Y-axis direction have the minimum temperature.

This is because heat moved from the lines 12b extending in the X-axis direction to the lines 12b extending in the Y-axis direction via junctions 12c where the lines 12b extending in the X-axis direction and the lines 12b extending in the Y-axis direction intersect, that is, the vertex portions of the regular square.

The maximum temperature illustrated at the middle sections of the lines 12b extending in the X-axis direction is 236.2° C., and the minimum temperature illustrated at the middle sections of the lines 12b extending in the Y-axis direction is 182.3° C.

The difference between the maximum temperature and the minimum temperature is as small as 53.9° C., showing that the temperature distribution in the lines 12b could be homogenized.

As a result, the maximum temperature is suppressed, and this enhances the electric power durability of the conductive mesh 12A.

In the cooking microwave oven which is the application target of the first embodiment, in order to eliminate uneven heating of a heating target object housed in the space 10a of the conductive housing 10, the electric field distribution in the space 10a of the conductive housing 10 is changed over time by rotating the emission direction of electromagnetic waves from the electromagnetic wave emitting unit 30, or, for example, in a case where the electromagnetic wave emitting unit 30 includes an antenna, by rotating the antenna.

In addition, the electric field distribution in the space 10a of the conductive housing 10 changes also depending on the size and position of a heating target object housed in the space 10a of the conductive housing 10.

As a result, the polarization direction of electromagnetic waves to be incident on the conductive mesh 12A changes variously, and the value of an electric current induced in lines 12b extending in the X-axis direction and lines 12b extending in the Y-axis direction also changes variously.

Since all the lengths of the lines 12b on the four sides enclosing each mesh cell 12a are the same in the conductive mesh 12A, the temperature rise in the lines 12b can be prevented no matter which direction the polarization direction of electromagnetic waves to be incident is, and the temperature at the middle sections of the lines 12b on the sides parallel to the polarization direction of the electromagnetic waves to be incident does not rise excessively, thereby enhancing the electric power durability of the conductive mesh 12A.

In addition, since the line widths of lines 12b are the same across the whole length in the conductive mesh 12A, the line widths of the lines 12b are the same for various polarization directions of electromagnetic waves to be incident, and the temperature does not rise extremely depending on the positions of the lines 12b, thereby enhancing the electric power durability of the conductive mesh 12A.

Without impairing the opening ratio of the conductive mesh 12A, that is, without impairing the transparency, that is, even when the line widths are reduced, stated differently, the see-through property is enhanced, by making all the lengths of the lines 12b on the four sides enclosing each mesh cell 12a the same, and making the line widths the same across the whole length, the temperature distribution in the lines 12b included in the conductive mesh 12A can be homogenized in a state where the maximum temperature on the conductive mesh 12A is lowered, even when the polarization direction of electromagnetic waves to be incident changes variously.

As a result, the conductive mesh 12A does not deteriorate due to burning or the like.

In addition, the present inventors examined the relationship between the size of mesh cells 12a and the temperature distribution through simulations.

In a case where a regular square which is the shape of each mesh cell 12a was proportionally increased in size, a tendency was observed where the maximum temperature increases, and the minimum temperature decreases as the size of each mesh cell 12a increases.

This is because it becomes difficult for the heat of the middle sections on the sides to move as the junctions 12c where lines 12b extending in the X-axis direction and lines 12b extending in the Y-axis direction intersect move farther from the middle sections.

On the basis of this, in a case where the shape is not a regular square, but, for example, is a shape in which the length of one side in the four sides is longer than the lengths of the other three sides, the maximum temperature is observed at the one longer side, and is higher than the maximum temperature in a case where the lengths of the four sides are made the same.

As a result, the longer side is more prone to deterioration due to burning or the like, and the electric power durability of the conductive mesh 12A worsens.

On the other hand, in a case where a regular square which is the shape of each mesh cell 12a is proportionally reduced in size, a tendency was observed where the maximum temperature decreases, and the minimum temperature increases as the size of each mesh cell 12a decreases, that is, the temperature distribution in lines 12b of the conductive mesh 12A becomes more homogenized as the size of a regular square which is the shape of each mesh cell 12a is reduced in size.

This is because it becomes easier for the heat of the middle sections on the sides to move as the junctions 12c where lines 12b extending in the X-axis direction and lines 12b extending in the Y-axis direction intersect approach the middle sections.

Note that since the opening ratio per unit area does not change even when a regular square which is the shape of each mesh cell 12a is proportionally increased or reduced in size, the transparency does not deteriorate.

As can be understood from what has been explained above, the less the lengths of the sides of each mesh cell 12a of the conductive mesh 12A are, the more homogenized the temperature distribution in the lines 12b included in the conductive mesh 12A is.

Stated differently, since the maximum temperature in the lines 12b included in the conductive mesh 12A is suppressed, the deterioration of the conductive mesh 12A can be more effectively avoided even in a case where electromagnetic waves with a high electric power density are incident on the conductive mesh 12A.

That is, the electric power durability of the conductive mesh 12A and the conductive housing 10 to which the conductive mesh 12A is applied can be further enhanced.

In the first embodiment, a high electric power density of electromagnetic waves refers to 1 mW/cm² or higher.

In the standard regulations for radio wave protection, RCR STD-38, by the Association of Radio Industries and Businesses, the upper limit value of the electric power density in general environments for 1.5 GHz to 300 GHz is set to 1 mW/cm². Accordingly, an electric power density of 1 mW/cm² or higher is defined as a high electric power density.

Note that, when it assumed that, in a household microwave oven, the high-frequency output of the electromagnetic wave generating unit 20 is 500 W, the area of an electromagnetic shield provided to the door section equivalent to the conductive mesh 12A is 500 cm² (=25 cm×20 cm), and all electromagnetic waves emitted by the electromagnetic wave emitting unit 30 are emitted uniformly onto the electromagnetic shield, the electric power density of electromagnetic waves that are incident on the electromagnetic shield is 1000 mW/cm².

The conductive mesh 12A shields not only electromagnetic waves with an electric power density of 1000 mW/cm², but also electromagnetic waves with an electric power density of 1 mW/cm² or higher.

Whereas the shape of each mesh cell 12a is a regular square in the example describe above, for the following reason, the shape is not limited to a regular square, but it is sufficient when the shapes of mesh cells 12a are regular n-gons, each enclosed by straight sides of equal length. n is a natural number which is equal to or greater than three.

That is, it is known that, among n-gons with a predetermined perimeter, regular n-gons have the largest areas.

Assuming that, in the conductive mesh 12A, a unit mesh includes lines 12b enclosing one mesh cell 12a, the lengths of all the lines 12b arranged on the respective sides included in each unit mesh are the same, and the widths of all the lines 12b are the same, and assuming also that the occupied area of the conductive mesh 12A remains the same, the area of each mesh cell 12a is maximized when the shape is a regular n-gon among n-gons as the shape of each mesh cell 12a.

In summary, in the conductive mesh 12A, by configuring a regular n-gon as the shape of each mesh cell 12a forming a geometric pattern in which mesh cells 12a are arranged planarly in close contact with each other in the vertical direction and the lateral direction, the opening ratio of the conductive mesh 12A as determined by the mesh cell 12a can be maximized.

For example, if the shape of each mesh cell 12a is an n-gon whose interior angles are not equal, but whose lengths of the respective sides are simply equal such as a rhombus as an example, it is necessary to increase the length of each side in order to achieve the same opening area as a regular square.

Accordingly, under the condition that the opening ratio (=sheet resistance) of the conductive mesh 12A remains the same, making the shape of each mesh cell 12a a regular n-gon allows for the minimum length of each side compared to the shape of each mesh cell 12a which is an irregular n-gon. As a result, this can most effectively homogenize the temperature distribution in lines 12b enclosing each mesh cell 12a.

In summary, by making the shapes of mesh cells 12a regular n-gons, each enclosed by straight sides of equal length, the electric power durability of the conductive mesh 12A can be enhanced.

Upon further investigation into the shapes of mesh cells 12a, the present inventors found out that, from the perspective of the electric power durability of the conductive mesh 12A, the shape of each mesh cell 12a is preferably a regular hexagon, a regular square, or an equilateral triangle, and the shape of each mesh cell 12a is particularly preferably a regular hexagon.

That is, mesh cells 12a which are regular hexagons, regular squares, or equilateral triangles can be arranged evenly without gaps across the plane of the conductive mesh 12A, achieving favorable results in terms of opening ratio and temperature distribution of the conductive mesh 12A.

Particularly, under the condition that the line widths of lines 12b and the opening ratio remain the same, making the shape of each mesh cell 12a a regular hexagon can most effectively achieve the minimum length of the respective sides of each mesh cell 12a and the homogenization of the temperature distribution in the lines 12b enclosing mesh cells 12a.

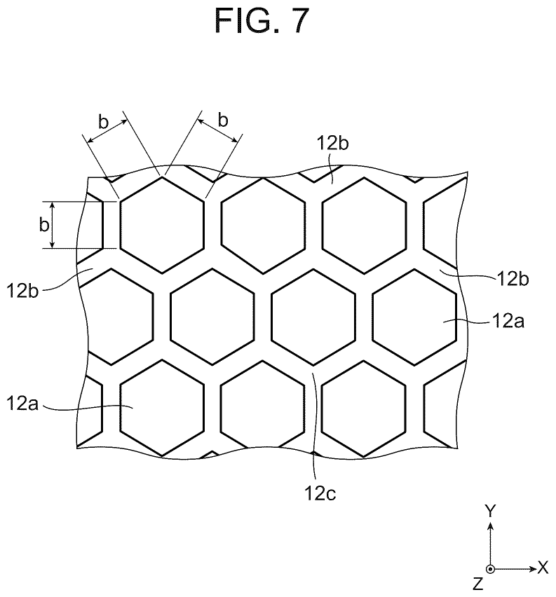

FIG. 7 illustrates a front view of main units of the conductive mesh 12A in which the shape of each mesh cell 12a is a regular hexagon whose length of each side is b (<a).

Considering this point, the present inventors conducted numerical simulations of the heat (temperature distribution) in the lines 12b enclosing mesh cells 12a in a case where electromagnetic waves are incident on the conductive mesh 12A, for the shape of each mesh cell 12a which is a regular hexagon and an equilateral triangle similarly to the case where the shape of each mesh cell 12a is a regular square explained above.

The numerical simulations were conducted on unit mesh models in which, for the shapes of respective mesh cells 12a, the line widths and line thicknesses of lines 12b remained the same, and the size of each mesh cell 12a was set in such a manner that the sheet resistance value of the conductive mesh 12A remained the same.

The numerical simulations of the temperature distribution in the lines 12b of each unit mesh were conducted after a certain length of time since the perpendicular entrance of an electromagnetic field (electromagnetic waves) into the plane of unit meshes under the condition that the temperature on one side of the lines 12b enclosing each mesh cell 12a rises most. That is, for the unit mesh model in which the shape of each mesh cell 12a is a regular hexagon, the electromagnetic wave polarization was parallel to the Y axis as illustrated in FIG. 5. For the unit mesh model in which the shape of each mesh cell 12a is an equilateral triangle, the electromagnetic wave polarization was parallel to the X axis as illustrated in FIG. 6.

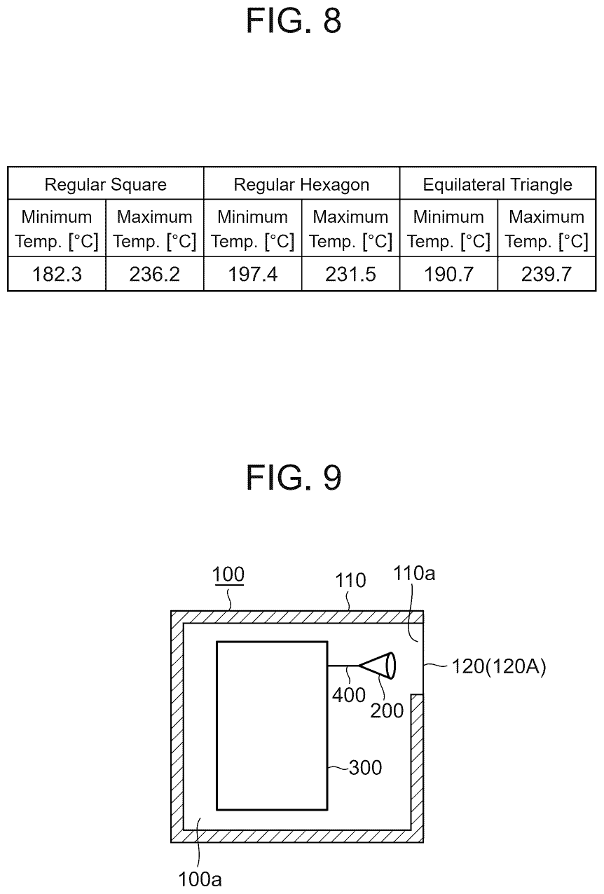

The maximum temperature and minimum temperature of lines 12b in each unit mesh model obtained through the temperature distribution numerical simulations are illustrated in FIG. 8.

The numerical simulation results illustrated in FIG. 8 were obtained using unit mesh models in which the line width was set to 7.5 μm across the whole length.

In the unit mesh model in which the shape of each mesh cell 12a is a regular hexagon, the maximum temperature was 231.5° C., the minimum temperature was 197.4, and the difference between the maximum temperature and the minimum temperature was 34.1° C.

In the unit mesh model in which the shape of each mesh cell 12a is an equilateral triangle, the maximum temperature was 239.7° C., the minimum temperature was 190.7, and the difference between the maximum temperature and the minimum temperature was 49.0° C.

Note that when the line width was 10 μm, similar results were obtained for the maximum temperature and the minimum temperature.

As can be understood from FIG. 8, the maximum temperature is the lowest in the regular hexagon unit mesh model, and the temperature distribution in the lines 12b of unit meshes also can be homogenized in the regular hexagon unit mesh model.

Note that although achieving the homogenization of the temperature distribution also resulted in an increased minimum temperature, the partial peeling of the conductive mesh 12A from the holder holding the conductive mesh 12A and the deformation of the conductive mesh 12A, which are precursors to deterioration such as burning, melting, and disconnection of the conductive mesh 12A, are caused by the expansion and deformation of the conductive mesh 12A and the holder at the point of maximum temperature. Accordingly, lowering the maximum temperature to homogenize the temperature distribution enhances the electric power durability of the conductive mesh 12A.

As explained above, in the conductive housing 10 in the electromagnetic wave heating device according to the first embodiment, the conductive mesh 12A in the second shield 12 that forms the electrically closed space between the first shield 11 and the second shield 12 has a shape in which a plurality of mesh cells, each enclosed by straight sides of equal length, are arranged in an array. Accordingly, the temperature distribution in the lines 12b enclosing the mesh cells 12a can be homogenized, the maximum temperature in the lines 12b can be lowered, and the electric power durability of the conductive mesh 12A can be enhanced.

Since the electric power durability of the conductive mesh 12A can be enhanced, the electric power durability of the conductive housing 10 also is enhanced.

Specifically, electromagnetic waves with an electric power density of 1 mW/cm² or higher are prevented from leaking outside the conductive housing 10, and the temperature distribution in the lines 12b included in the conductive mesh 12A can be homogenized in a state where the maximum temperature on the conductive mesh 12A is lowered even when the line widths of the lines 12b are reduced to increase the opening ratio, that is, to enhance the transparency. Accordingly, the conductive mesh 12A does not deteriorate due to burning and the like.

Furthermore, in the electromagnetic wave heating device, the electric power durability of the conductive mesh 12A where electromagnetic waves from the electromagnetic wave emitting unit 30 are incident with a high electric power density can be enhanced, without causing impairment to transparency.

### Second Embodiment

A sensor device according to a second embodiment is explained using FIG. 9.

For example, the sensor device according to the second embodiment is any of sensor devices that are attached to manned or unmanned vehicles, flying objects including aircrafts, ships, and the like.

Since main constituent elements of these sensor devices are the same, the sensor devices are explained without making distinctions therebetween.

The sensor device according to the second embodiment includes a conductive housing 100, a sensor element 200, and a sensor processing device 300.

FIG. 9 schematically illustrates the conductive housing 100, the sensor element 200, and the sensor processing device 300.

The conductive housing 100 has a first shield 110 and a second shield 120.

The first shield 110 is a conductive structure having an opening 110a.

In a case where the sensor device is a sensor device mounted on a flying object or a ship, the first shield 110 may be part or the whole of a conductive structure of the flying object or the ship.

For example, a first shield 11 is formed using carbon steel, special steel, or a conductive material of another alloy.

The second shield 120 is provided at the opening 110a of the first shield 110, and has a conductive mesh 120A and a holder (not illustrated) that holds the conductive mesh 120A.

The end of the perimeter of the holder is mounted on the end of the perimeter of the opening 110a of the first shield 110.

The first shield 110 and the second shield 120 form a space 100a of the conductive housing 100.

The sensor element 200 and the sensor processing device 300 are housed in the space 100a of the conductive housing 100.

FIG. 9 schematically illustrates the first shield 11 and a second shield 12.

The conductive mesh 120A is electrically connected to the first shield 110 to form an electrically closed space between the first shield 110 and the conductive mesh 120A, or a so-called closed space, as an internal space 100a of the conductive housing 100.

As explained regarding the first embodiment, the electrical connection between the conductive mesh 120A and the first shield 110 is not limited to an electrical connection established by causing the conductive mesh 120A to contact the first shield 110 around the entire perimeter of the end of the opening 110a of the first shield 110, but also includes a connection through contact or capacitive coupling at a narrow spacing that achieves sufficient capability to shield electromagnetic waves that are incident on the conductive mesh 120A from outside the conductive housing 100.

The electromagnetic waves that are incident on the conductive mesh 120A from outside the conductive housing 100, and are shielded explained here are so-called radio waves whose wavelength is longer than infrared light in a case where the sensor element 200 is an infrared camera.

The holder that holds a conductive mesh 12A covers the whole surface of the conductive mesh 12A, and has a flat plate shape formed using a light-transmitting material of inorganic glass or heat-resistant polyimide.

The first shield 110 and the conductive mesh 120A function as a so-called conductor shield that prevents electromagnetic waves from entering the space 100a of the conductive housing 100 from outside the conductive housing 100, that is, shields electromagnetic waves between the outside of the conductive housing 100 and the space 100a of the conductive housing 100.

Specifically, for example, to prevent highly strong electromagnetic pulses that are generated due to the occurrence of lightning from entering the conductive housing 100, and destroying the sensor element 200 disposed inside the conductive housing 100, a shield structure that shields electromagnetic waves from entering the space 100a of the conductive housing 100 from outside the conductive housing 100 is formed by the first shield 110 and the conductive mesh 120A.

The sensor element 200 is a sensor element that uses visible light or infrared light to capture images of the outside of the space 100a of the conductive housing 100 from inside the space 100a through the conductive mesh 120A, and typically is a visible light camera or an infrared camera.

The first shield 110 and the conductive mesh 120A function as a conductor shield for electromagnetic waves with a wavelength which is longer than the wavelength of visible light in a case where the sensor element 200 is a visible light camera, and function as a conductor shield for radio waves which are electromagnetic waves with a wavelength which is longer than the wavelength of infrared light in a case where the sensor element 200 is an infrared camera.

The sensor element 200 is housed and disposed in the space 100a of the conductive housing 100, with its lens facing the conductive mesh 120A.

An information acquiring section of the sensor element 200 including the lens receives visible light or infrared light having passed through the conductive mesh 120A, and acquires information from outside the space 100a of the conductive housing 100.

The sensor element 200 senses, that is, captures images of, a subject which is outside the space 100a of the conductive housing 100.

For example, external information acquired by the sensor element 200 is visual information.

The external information acquired by the sensor element 200 is processed by the sensor processing device 300, and is stored on a storage device (not illustrated) or transferred to another device (not illustrated) through a cable or wirelessly.

The sensor processing device 300 is housed in the space 100a of the conductive housing 100, and is electrically connected to the sensor element 200 through a cable 400.

Note that it is sufficient if the sensor processing device 300 is electrically connected to the sensor element 200 through the cable 400, and the sensor processing device 300 may be arranged outside the space 100a of the conductive housing 100.

Since the sensor element 200 and the cable 400 are housed in the space 100a of the conductive housing 100 that functions as a conductor shield, the sensor element 200 and the cable 400 are not exposed to electromagnetic waves from outside the space 100a of the conductive housing 100. There is no possibility of induction of large electric currents due to the exposure of the sensor element 200 and the cable 400 to electromagnetic waves, and there is no possibility of destruction of semiconductor components and electronic circuits included in the sensor element 200 and the sensor processing device 300 due to the induction of large electric currents.

Similarly to the conductive mesh 12A in the first embodiment, the conductive mesh 120A has a shape in which mesh cells 12, each enclosed by straight sides of equal length, are arranged in an array.

The shapes of mesh cells are regular n-gons, each enclosed by straight sides of equal length. n is a natural number which is equal to or greater than three.

From the perspective of the electric power durability of the conductive mesh 120A, the shape of each mesh cell is preferably a regular hexagon, a regular square, or an equilateral triangle, and the shape of each mesh cell is particularly preferably a regular hexagon.

The maximum distance between the sides enclosing each mesh cell in the conductive mesh 120A is equal to or less than the wavelength of electromagnetic waves that are incident on the conductive mesh 120A from outside the conductive housing 100, and the minimum distance between the sides is longer than the wavelength of visible light or infrared light.

In a case where the shape of each mesh cell 12a is a regular square, the length of each diagonal is equal to or less than the wavelength of the electromagnetic waves, and the length a of each side is a length longer than the wavelength of visible light or infrared light.

In a case where the shape of each mesh cell 12a is a regular hexagon, the length of each line segment linking opposite corners is equal to or less than the wavelength of the electromagnetic waves, and the distance between each pair of opposite sides is a length longer than the wavelength of visible light or infrared light.

In a case where the shape of each mesh cell 12a is an equilateral triangle, the length of each side is equal to or less than the wavelength of the electromagnetic waves, and the length of each perpendicular line is a length longer than the wavelength of visible light or infrared light.

That is, the conductive mesh 120A allows visible light or infrared light to pass through, and shields electromagnetic waves with a wavelength longer than the wavelength of visible light or infrared light.

Accordingly, since the conductive mesh 120A shields electromagnetic waves with a wavelength which is longer than the wavelength of visible light and allows visible light to pass through in a case where the sensor element 200 is a visible light camera, the visible light camera and the cable connected to the visible light camera are not exposed to electromagnetic waves from outside the space 100a of the conductive housing 100 while the visible light camera fulfills its primary purpose of capturing images of subjects outside the space 100a of the conductive housing 100 through the conductive mesh 120A. Therefore, there is no possibility of destruction of semiconductor components and electronic circuits included in the visible light camera and the sensor processing device 300.

In addition, since the conductive mesh 120A shields radio waves which are electromagnetic waves with a wavelength which is longer than the wavelength of infrared light and allows infrared light to pass through in a case where the sensor element 200 is an infrared camera, the infrared camera and the cable connected to the infrared camera are not exposed to electromagnetic waves from outside the space 100a of the conductive housing 100 while the infrared camera fulfills its primary purpose of capturing images of subjects outside the space 100a of the conductive housing 100 through the conductive mesh 120A. Therefore, there is no possibility of destruction of semiconductor components and electronic circuits included in the infrared camera and the sensor processing device 300.

Furthermore, the shape of each mesh cell is a regular n-gon in the conductive mesh 120A. Accordingly, in a case where electromagnetic waves from outside the space 100a of the conductive housing 100 are incident on the conductive mesh 120A, even when an electric current due to electromagnetic waves is induced in lines included in the conductive mesh 120A, and the temperature of the lines rises, the temperature distribution in the lines included in the conductive mesh 120A is homogenized, the maximum temperature can be lowered, and the electric power durability of the conductive mesh 120A is enhanced as explained in the first embodiment.

In addition, as explained in the first embodiment, the shape of each mesh cell is preferably a regular hexagon, a regular square, or an equilateral triangle, and the shape of each mesh cell is particularly preferably a regular hexagon.

Note that when the line width was 7.5 μm, results similar to those illustrated in FIG. 8 were obtained at the maximum temperature and the minimum temperature, and when the line width was equal to or less than 10 μm, similar results were also obtained.

As explained above, in the conductive housing 100 in the sensor device according to the second embodiment, the conductive mesh 120A in the second shield 120 that forms the electrically closed space between the first shield 110 and the second shield 120 has a shape in which a plurality of mesh cells, each enclosed by straight sides of equal length, are arranged in an array. Accordingly, the temperature distribution in the lines enclosing the mesh cells can be homogenized, the maximum temperature in the lines can be lowered, and the electric power durability of the conductive mesh 120A can be enhanced.

Since the electric power durability of the conductive mesh 120A can be enhanced, the electric power durability of the conductive housing 100 is also enhanced.

Furthermore, in the sensor device, the sensor element 200 can acquire information on outside the space 100a of the conductive housing 100 through the conductive mesh 120A; moreover, the entrance of electromagnetic waves that are incident on the conductive mesh 12A from outside the space 100a of the conductive housing 100 into the space 100a of the conductive housing 100 is inhibited, and the destruction of semiconductor components and electronic circuits included in the sensor element 200 and the sensor processing device 300 due to electromagnetic waves from outside the space 100a of the conductive housing 100 is prevented.

Note that modification of any constituent element in the embodiment, or omission of any constituent element in the embodiment is possible.

### Industrial Applicability

The conductive housing according to the present disclosure can be applied as a conductive housing of a device such as a cooking microwave oven or a microwave heating device for heating a heating target object which is the target object to be heated by emitting electromagnetic waves onto the heating target object or as a conductive housing in a sensor device having a built-in camera.

### REFERENCE SIGNS LIST

10: Conductive housing; 10a: Space; 11: First shield; 11a: Opening; 12: Second shield; 12A: Conductive mesh; 12a: Mesh cell; 12b: Line; 20: Electromagnetic wave generating unit; 30: Electromagnetic wave emitting unit; 100: Conductive housing; 100a: Space; 110: First shield; 110a: Opening; 120: Second shield; 120A: Conductive mesh; 200: Sensor element; 300: Sensor processing device

1. An electromagnetic wave heating device comprising:
a conductive housing including a first shield being conductive and having an opening, and a second shield that has a conductive mesh with a shape in which a plurality of mesh cells, each enclosed by straight sides of equal length each having a line width being equal to or less than 10 μm, are arranged in an array, and is provided at the opening of the first shield, the conductive mesh being electrically connected to the first shield to form an electrically closed space by the first shield and the second shield;
an electromagnetic wave generator to generate an electromagnetic wave; and
an electromagnetic wave emitter that is housed inside the conductive housing, and emits the electromagnetic wave from the electromagnetic wave generator into a space of the conductive housing,
wherein electrical connection between the first shield and the conductive mesh in the second shield is established at points of contact or capacitive coupling between the first shield and the conductive mesh of the second shield arranged with an interval which is equal to or less than 1/10 of a wavelength of the electromagnetic wave generated by the electromagnetic wave generator.

2. The electromagnetic wave heating device according to claim 1, wherein the second shield has a light-transmitting holder to hold the conductive mesh.

3. The electromagnetic wave heating device according to claim 2, wherein the holder is inorganic glass or heat-resistant polyimide.

4. The electromagnetic wave heating device according to claim 1, wherein a shape of each of the plurality of mesh cells in the conductive mesh is a regular n-gon (n is a natural number which is equal to or greater than three).

5. The electromagnetic wave heating device according to claim 1, wherein a shape of each of the plurality of mesh cells in the conductive mesh is any of a regular hexagon, a regular square, and an equilateral triangle.

6. The electromagnetic wave heating device according to claim 1, wherein a shape of each of the plurality of mesh cells in the conductive mesh is a regular hexagon.

7. The electromagnetic wave heating device according to claim 1, wherein a maximum distance between sides enclosing each of the plurality of mesh cells in the conductive mesh is equal to or less than a wavelength of an electromagnetic wave that are incident on the conductive mesh, and a minimum distance between the sides is longer than a wavelength of visible light or infrared light.

8. The electromagnetic wave heating device according to claim 1, wherein lines enclosing each of the plurality of mesh cells in the conductive mesh have a same width across a whole length.
